(19) United States
(12) Patent Application Publication
(10) Pub. No.: US 2004/0208238 A1
(43) Pub. Date: Oct. 21, 2004

(54) Systems and methods for location estimation in spread spectrum communication systems

(76) Inventors: John K. Thomas, Erie, CO (US); Anand P. Narayan, Boulder, CO (US); Eric S. Olson, Boulder, CO (US)

Correspondence Address: TENSORCOMM, INC., 1490 W. 121ST AVE., SUITE 105, WESTMINISTER, CO, 80234, US

(21) Appl. No.: 10/838,924

(22) Filed: May 3, 2004

Related U.S. Application Data
(63) Continuation-in-part of application No. 10/178,541, filed on Jun. 25, 2002, now Pat. No. 6,750,818.
(63) Continuation-in-part of application No. 10/294,834, filed on Nov. 15, 2002.
(63) Continuation-in-part of application No. 10/773,777, filed on Feb. 6, 2004.
(63) Continuation-in-part of application No. 10/669,954, filed on Sep. 23, 2003.
(63) Continuation-in-part of application No. 10/686,829, filed on Oct. 15, 2003.
(63) Continuation-in-part of application No. 10/699,360, filed on Oct. 31, 2003.
(63) Continuation-in-part of application No. 10/763,346, filed on Jan. 23, 2004.

(51) Int. Cl. H04B 1/707

(52) U.S. Cl. 375/148

(57) ABSTRACT

Systems and methods for assisting in location estimation are presented. In one embodiment of the invention, a system improves performance of known location determination algorithms through the use of interference cancellation. In general, the system selectively cancels certain signals to improve Signal to Noise Ratios (SNRs) of certain other signals in a spread spectrum system. These improved SNRs enhance processing, which assists in ascertaining a location of a mobile handset. For example, with improved SNR, the handset may be more able to process signals from more base stations. This processing of additional signals can improve location estimation because certain known location determination algorithms can be used (e.g., TOA and AOA) and location ambiguities and can be resolved.

### CROSS REFERENCE TO RELATED APPLICATIONS

This application is a continuation-in-part application of U.S. patent application Ser. No. 10/178,541 (filed Jun. 25, 2002; the “'541 application”), Ser. No. 10/294,834 (filed Nov. 15, 2002; the “'834 application”), Ser. No. 10/773,777 (filed Feb. 6, 2004; the “'777 application”), Ser. No. 10/669,954 (filed Sep. 23, 2003; the “'954 application”), Ser. No. 10/686,829 (filed Oct. 15, 2003; the “'829 application”), Ser. No. 10/699,360 (filed Oct. 31, 2003; the “'360 application”), and Ser. No. 10/763,346 (filed Jan. 23, 2004; the “'346 application”), which are each hereby incorporated by reference.

### BACKGROUND OF THE INVENTION

1. Field of the Invention

The present invention generally relates to locating a mobile transmitter within a spread spectrum communication network, and more specifically to a system and method for position location estimation using signal cancellation in a spread spectrum network such as those using Code Division Multiple Access (“CDMA”), Wideband Code Division Multiple Access (“W-CDMA”), Global Positioning System (“GPS”) systems or combinations thereof.

2. Description of the Related Art

It is becoming increasingly more important to be able to geolocate a mobile telephone unit within a wireless network for, among other reasons, personal safety. As the number of wireless subscribers increase and as an increasing number of emergency calls (i.e., “E-911 calls”) are expected to originate from mobile telephones, the Federal Communication Commission (“FCC”) has mandated that wireless network service providers provide a system which can determine locations of an E-911 caller within 125 meters at least 67% of the time. Determined locations are then to be forwarded to a Public Safety Answering Point (“PSAP”) to facilitate emergency response. Further, the service providers are becoming more interested in commercial applications involving location based services (“LBS”) as an additional source of revenue generation.

A number of position location techniques have been suggested in the art. For example, handset-based solutions have been proposed such that the handset has the capability, using GPS to ascertain its location with respect to the known, fixed locations of the base stations. Alternative solutions include using time of arrival (“TOA”) of “forward-link” base station to mobile signals from at least two base stations, using the signal to noise ratio (“SNR”) of the signals, or using a combination of the GPS and TOA techniques. The basic principle of location computation for “forward-link” handset-based solutions is to receive signals from two or more base stations and use signal parameters (e.g., SNR, TOA, et cetera) to estimate the location of the handset from each of the base stations. Since the position of the base stations is known, knowledge of the relative position between the two or more fixed locations can provide an estimate of the location of the mobile station.

Additionally, “network-based solutions” have been proposed. These network-based solutions also involve two or more base stations simultaneously ascertaining the location of the mobile phone of interest. The mobile phone's location relative to the base stations is determined using a “reverse-link” mobile-to-base-station signal's angles of arrival (“AOA”), TOAs or SNRs. An SNR of such a signal, for example, is compared to pre-computed SNRs expected for different locations. Thus, in a network-based solution, two or more base stations may receive the signal from a mobile station in a reverse link traffic and the signal's parameters (i.e., AOA, TOA or SNR) are used by each base station to estimate the relative location of the mobile station and consequently the actual location.

There are some deficiencies, however, in the position location methods heretofore available. For example, there are significant drawbacks to using a GPS in a handset-based solution because the use of GPS involves additional hardware. Moreover, GPS only solutions for mobile stations often involve long acquisition times for the GPS signal and require additional power because of the added hardware. While GPS solutions can alleviate some of these deficiencies, the GPS receivers of the mobile receiver can have poor reception inside buildings thereby minimizing the effectiveness of the solution.

Methods based on AOA solutions can also be susceptible to errors when a base station and a mobile station are proximately situated. Reflections of buildings can also cause changes in AOAs and induce errors. Additionally, interference from “stronger” interfering sources may hinder selected signal sources from being accurately received causing location errors when processed.

Both network and handset-based solutions that depend on TOA and AOA techniques often share a problem wherein a mobile transmitter cannot “see” the base stations needed to accurately locate the transmitter because of the “near-far” problem. For example, interference from a stronger base station on the forward link can contribute to the interference seen by a receiver processing weaker base stations signals. Thus, while a strong signal, or high SNR, is useful for location determinations, a strong signal may impede the reception of other signals and thereby degrade the performance of a location determination algorithm.

Interference from other mobile transmitters in the network-based solutions can also hinder reception of a selected mobile handset signal by the base stations on the reverse link. This occurs primarily because signals from the other mobile handsets sharing the same bandwidth can create interference with one base station's ability to detect and process the signal from the mobile station requesting location service.

While a number of approaches attempt to resolve the near-far problem, some have practical implementation barriers due to the potential disruption of communications for other served mobiles. A device capable of receiving and processing signals from multiple transmitters can improve a location estimate because, among other reasons, location determination algorithms are better able to resolve location ambiguities with additional sources in the forward link. Similarly, additional receivers in the reverse link provide similar improvements for the reverse link. However, in practical conditions, this is often not possible because interference provides an impediment to various position location techniques. For example, in spread spectrum systems many signal sources can share the same bandwidth at the same time thereby possibly interfering with a selected signal.

To illustrate the interference problem inherent in spread spectrum networks, the following discussion using a CDMA telephony system is useful. Each base station within a CDMA telephony system uses coded signals to communicate with mobile telephones. For example, typical CDMA telephony systems use pseudorandom number (PN) spreading codes (e.g, in one example referred to as “short codes”) on the forward link to encode data signals. These encoded data signals are transmitted to and from mobile telephones to convey digitized voice, data and/or other forms of communication. PN codes are known to those skilled in the art.

To encode the data signals, the base station applies a short code to the data at a rate that is faster than that of the data. For example, the short code is applied to the data such that there are multiple “chips” of the code for any given element of data. Such an application of the spreading code is commonly referred to as direct sequence spreading of the data. Chips and their associated chip rates are known to those skilled in the art. Often, each base station is assigned a particular timing offset of the short code to differentiate between base stations. Mobile telephones may therefore determine the identity of a particular base station based on the timing offset of the short code. Additionally, the data signals are often further encoded with a unique “covering” code. Such covering codes provide “channelization” for a signal that increases the possible number of users in the system.

These covering codes are often used in CDMA telephony systems and typically include families of codes that are orthogonal (e.g., a Walsh code) or codes that are substantially orthogonal (e.g., Quasi-Orthogonal Functions “QOF”). Walsh covering codes and QOF covering codes have properties that allow for the differentiation of signals and are known to those skilled in the art.

Both the spreading codes and the covering codes assist in the detection and acquisition of a selected signal. However, interference caused by other signals may still degrade data extraction capabilities of the selected signal. For example, as a mobile telephone communicates with a particular base station within that base station's coverage cell, signals from other base stations and mobiles can interfere with the mobile telephone communication on the reverse and forward link respectively. Since cells often overlap one another to ensure that most if not all desired geographic regions are included in the communication system's coverage area, one or more signals from one base station may interfere with the communication link, or “channel,” between the mobile telephone and another base station. This effect is commonly referred to as cross-channel interference.

These channels can “bleed” over into other cells and interfere with a selected signal, thereby corrupting conveyed data. Examples of such channels include pilot channels which convey reference information and are also used to coherently demodulate channels. Other potentially interfering channels may convey paging information that alerts a particular mobile telephone to an incoming call and synchronization information that provides synchronization between a mobile telephone and a base station. Traffic channels are still other examples of channels, which convey digital information (e.g., data and/or digital voice) and also interfere.

Still, other forms of interference may occur from “multipath” copies of a selected signal. Multipath can create interference because of the reception of copies of a selected signal. Multipath typically occurs because of obstructions, such as buildings, trees, et cetera, that can create multiple transmission paths for a selected signal. These separate transmission paths may have unique distances that cause the signal to arrive at a receiver at differing times and/or differing phase. This is commonly referred to as co-channel interference. Additionally, these separate paths may bleed over into other cells causing cross-channel interference.

Multipath creates co-channel interference because, among other reasons, the orthogonality of the covering code for a received signal is essentially lost due to timing offsets associated with the multipath. For example, a multipath signal having a covering code and arriving at a receiver at differing times may cause a misalignment of the covering code. Such a misalignment can result in a high cross-correlation and can result in a general inability to correctly retrieve conveyed data.

“Rake” receivers, such as those used in CDMA telephony systems, can assist in advantageously combining multipath signals. For example, a rake receiver may have a plurality of “fingers,” wherein each finger of the rake receiver independently estimates channel gain and other signal characteristics (e.g., phase) of an assigned signal path for subsequent combination of the signal paths. This combination of the paths leads to more accurate demodulation and retrieval of data of a selected signal. A signal path as used herein generally refers to one or more signals, referred to as channels, associated with a particular PN code sequence and which follow a particular physical path. Such a signal path may have an associated timing alignment in the spreading code, such as that associated with multipath signals and/or assigned offsets of unique CDMA base stations. These one or more channels of a particular signal path are encoded with a covering code.

Each finger of the rake receiver is assigned a particular signal path of a selected signal. Additionally, as signal characteristics change, the fingers may be assigned or de-assigned to other signal paths to improve data retrieval. Rake receivers can improve data retrieval of a received signal via signal combining. However, present rake receivers do not substantially reduce cross-channel interference and/or co-channel interference. These types of interference may still corrupt data as long as they exist in any substantial form.

### SUMMARY OF THE INVENTION

Systems and methods for assisting in location estimation are presented. In one embodiment of the invention, a system improves performance of known location determination algorithms through the use of interference cancellation. In general, the system selectively cancels certain signals to improve SNRs of certain other signals in a spread spectrum system. These improved SNRs enhance processing which may assist in ascertaining a location of a mobile handset. For example, with an improved SNR, the handset may be better able to process signals from more transmitters. This processing of additional signals can improve location estimation.

Thus, in accordance with one broad aspect of the present invention, handset location estimation is improved by improving SNRs of those signals with selective interference cancellations and thereby identifying and tracking more signals. In one exemplary embodiment of the present invention, cancellation of signals interfering with the pilot channel of a first base station may increase the SNR of that pilot channel for improved tracking in one of the processing fingers of a handset receiver. Consequently, the pilot channel of the first base station, as well as other interfering signals, may be cancelled to improve the SNR of a pilot channel of a second base station for subsequent improved tracking in another finger. Such signal cancellation may continue until a predetermined location resolution is achieved.

According to another broad aspect of the present invention, handset location estimation is improved by allowing a searcher finger of a handset receiver to search over cancelled signals to detect base station signals previously not visible. In another exemplary embodiment of the present invention, a signal cancellation system and method of the present invention cancels certain interferers from a received signal y and transfers the output cancelled signal y′ to the searcher finger of the receiver. Since certain interfering signals have been cancelled, the searcher finger is better able to detect other signals that were previously “buried” by the interfering signals. In yet another exemplary embodiment of the present invention, an auxiliary searcher finger could be implemented for searching over cancelled signals while the current searcher continues to search over non-cancelled signals.

In a first preferred embodiment, a mobile handset processes a pilot channel from a first base station, and a searcher finger searches for a pilot channel of a second base station. Once the pilot channel of the second base station is located, a Coded Signal Processing Engine (CSPE), as decided by a controller, cancels the first pilot channel and other channels associated with the signal path to determine if the SNR of the second pilot channel is improved. If the SNR is improved, the second pilot channel is tracked by a processing finger of the receiver using the cancelled signal. If the SNR is not improved, the second pilot channel is tracked by a processing finger using the uncancelled signal. If the SNR is insufficient and the CSPE cannot improve the SNR, the CSPE considers a third pilot channel. The cancellation process continues until a desired number of unique base station signals are tracked and/or a desired resolution for the location algorithm is reached. Such resolution and/or number of base stations are a matter of design choice and may be chosen based on the impact to processing capabilities and/or requirements.

In a second preferred embodiment, a mobile handset locates a pilot channel from a first base station, and a CSPE cancels the pilot channel and other associated channels from a signal. The CSPE subsequently transfers that output cancelled signal to a searcher finger of the receiver. The searcher finger then searches for a pilot channel of a second base station. Once the pilot channel of the second base station is located, the CSPE, as decided by the controller, cancels the second pilot channel and other associated channels from the signal. The cancelled signal is transferred to the searcher to search for a pilot channel of a third base station.

Similar to the first preferred embodiment, if the SNR is improved using the interference cancelled signal then the third pilot channel is tracked by a processing finger using the cancelled signal. If the SNR is insufficient and the CSPE cannot improve the SNR, the third pilot channel may be dropped from the location algorithm entirely in favor of a fourth pilot channel. The cancellation process continues based on the desired resolution and/or the desired number of base stations of the location algorithm. Such resolution and location estimation algorithms are again a matter of design choice and may be chosen based on the impact to processing capabilities.

In one embodiment of the invention, a system for estimating a position location of a mobile station in a spread spectrum system comprises:

a processing engine configured to selectively and substantially cancel one or more interfering signals from a digital signal and to generate one or more interference cancelled output signals;

a receiver communicatively coupled to the processing engine and configured for processing the one or more interference cancelled output signals to generate signaling information; and

a location processor configured to process the signaling information to generate a location estimate.

In another embodiment of the invention, the processing engine comprises an interference selector configured for selecting said one or more interfering signals for cancellation.

In another embodiment of the invention, the processing engine further comprises a matrix generator configured for generating an interference matrix from selected said one or more interfering signals.

In another embodiment of the invention, the processing engine further comprises a processor configured for generating a cancellation operator from the interference matrix.

In another embodiment of the invention, the processing engine further comprises an applicator configured for applying the cancellation operator to the digital signal to substantially cancel the selected said one or more interfering signals and to generate one of the one or more interference cancelled output signals.

In another embodiment of the invention, the projection operator substantially comprises the form:

Pₛ^{⊥}=I−S(S^{T}S)⁻¹S^{T},

where Pₛ^{⊥} is the projection operator, I is an identity matrix, S is the matrix and S^{T} is a transpose of the matrix.

In another embodiment of the invention, the receiver comprises a plurality of processing fingers, wherein each processing finger is configured for processing one of the one or more interference cancelled output signals to generate a portion of the signaling information.

In another embodiment of the invention, the system further comprises a first searcher finger configured for receiving one of the one or more interference cancelled output signals to detect a selected signal.

In another embodiment of the invention, the first searcher finger is configurable with at least one of the receiver and the processing engine.

In another embodiment of the invention, the first searcher finger is communicatively coupled with a second searcher finger, wherein the second searcher finger is configured for receiving an uncancelled signal.

In another embodiment of the invention, the system is configurable with a mobile handset.

In another embodiment of the invention, the location processor is further configured to use GPS information to assist the location processor in generating the location estimate.

In another embodiment of the invention, the spread spectrum system is a CDMA system, a W-CDMA system or a GPS system.

In one embodiment of the invention, a method of estimating a location of a mobile station in a spread spectrum system comprises:

processing a first signal to generate signaling information of the first signal in response to receiving a location request;

substantially canceling the first signal to process a second signal and to generate signaling information of the second signal; and

generating a location estimate from the signaling information of the second signal.

In another embodiment of the invention, generating the location estimate comprises processing the signaling information of the first signal and processing the signaling information of the second signal to generate the location estimate.

In another embodiment of the invention, the method further comprises substantially canceling the second signal to process a third signal and to generate signaling information of the third signal.

In another embodiment of the invention, generating the location estimate comprises processing the signaling information to generate the location estimate, wherein the signaling information is selected from a group consisting of: the signaling information of the first signal; the signaling information of the second signal; and the signaling information of the third signal.

In another embodiment of the invention, processing the signaling information to generate the location estimate comprises processing the signaling information using one or more location algorithms selected from a group consisting of: Time of Arrival, Angle of Arrival; Frequency of Arrival; Time Difference of Arrival; and Frequency Difference of Arrival.

In another embodiment of the invention, comprising processing GPS information to assist in generating the location estimate.

In another embodiment of the invention, comprising acquiring the second signal with a searcher finger in response to substantially canceling the first signal.

In one embodiment of the invention, a method of estimating a position location of a mobile station in a spread spectrum system comprises:

processing a first signal to generate signaling information of the first signal;

determining if substantially canceling the first signal improves signal quality in a second signal;

substantially canceling the first signal to process the second signal and to generate signaling information of the second signal in response to determining that the signal quality of the second signal is improved; and

generating a location estimate using the signaling information of the second signal.

In another embodiment of the invention, comprising receiving a location request that initiates the method of estimating the location.

In another embodiment of the invention, comprising acquiring the first signal with a second searcher finger.

In one embodiment of the invention, a system for estimating a location of a mobile station in a spread spectrum system comprises:

means for processing a first signal to generate signaling information of the first signal in response to receiving a location request;

means for substantially canceling the first signal to process a second signal and to generate signaling information of the second signal; and

means for generating a location estimate from the signaling information of the second signal.

In one embodiment of the invention, a system for estimating a position location of a mobile station in a spread spectrum system comprises:

means for processing a first signal to generate signaling information of the first signal;

means for determining if substantially canceling the first signal improves signal quality in a second signal;

means for substantially canceling the first signal to process the second signal and to generate signaling information of the second signal in response to determining that the signal quality of the second signal is improved; and

means for generating a location estimate using the signaling information of the second signal.

### BRIEF DESCRIPTION OF THE DRAWINGS

FIG. 1 is a diagram illustrating forward link interference in a CDMA system.

FIG. 2 is a block diagram of a system in one exemplary embodiment of the invention.

FIG. 3 is a block diagram of a system illustrating components of a CSPE in one exemplary embodiment of the invention.

FIG. 4 is a block diagram of a system illustrating a first exemplary embodiment of a receiver operable with a CSPE and a location processor in one exemplary embodiment of the invention.

FIG. 5 is a block diagram of a system illustrating a second exemplary embodiment of a receiver operable with a CSPE and a location processor in one exemplary embodiment of the invention.

FIG. 6 is a block diagram of a system illustrating a third exemplary embodiment of a receiver operable with a CSPE and a location processor in one exemplary embodiment of the invention.

FIG. 7 is a flowchart in one exemplary methodical embodiment of the invention.

FIG. 8 is another flowchart in one exemplary methodical embodiment of the invention.

FIG. 9 is a block diagram of a system illustrating a fourth exemplary embodiment of a receiver operable with a CSPE and a location processor in one exemplary embodiment of the invention.

### DETAILED DESCRIPTION OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

In general, interference cancellation improves on existing position location determination systems by improving SNRs of signals to better process signals and/or to acquire more base station signals. For example, signal cancellation of signals interfering with a pilot channel of a first base station can increase the SNR of that pilot channel for improved tracking in a processing finger of a handset receiver. Similarly, signal cancellation of interfering signals can improve acquisition of signals. Consequently, the pilot channel of the first base station (as well as other interfering signals) may be cancelled to improve the SNR of a pilot channel of a second base station for subsequent improved tracking in another processing finger or acquisition in a searcher finger. Such signal cancellation may continue until a predetermined location resolution is achieved.

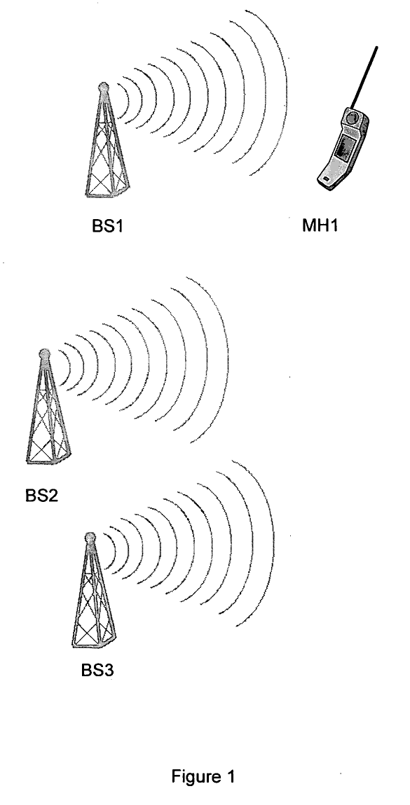

FIG. 1 is a diagram illustrating interference in a CDMA system. In this figure, mobile handset MH1 is proximately situated to base station BS1, and thus interference from the base station BS1 can limit mobile handset MH1's ability to receive and detect signals from base stations BS2 and BS3. This interference can prevent the accurate location estimate of the mobile station. Additionally, for a reverse link network-based location calculation, the low transmit power of MH1 may prevent the signal from MH1 from being detected by BS2 and BS3.

Signal cancellation of the signals from base station BS1 can improve detection of base stations BS2 and BS3 by mobile handset MH1 on the forward link. Similarly, base stations BS2 and BS3 can improve detection of a signal from mobile handset MH1 via signal cancellation on the reverse link. For example, as a typical received signal comprises a plurality of interfering signals in addition to a selected signal, removal of the interfering signals may increase the SNR of the selected signal. In one embodiment of the invention, a CSPE selectively cancels certain interfering signals to increase the SNR of a selected signal. This increased SNR improves location estimation because, among other reasons, a receiver is more apt to detect and/or process the selected signal accurately.

Theoretically, reception of a single line of sight (LOS) signal will lead to a location estimate that is limited to a radial location within the radiation pattern of the transmitter, this location estimate can be refined through the combination of other known location determination algorithms or through the reception of additional signals from additional transmitters. In this theoretical example, the addition of a LOS signal from a second base station can improve the location estimate because two radial locations (i.e., one for each of the two base stations) can intersect and provide up to two potential locations for the mobile transmitter. A LOS signal from a third base station can improve the location estimate even further by having three radial locations potentially intersect at a single point. Known location algorithms (e.g., TOA, AOA, SNR comparison, et cetera) can process one or more of these radial estimates and more accurately estimate a location of the mobile handset MH1. In a practical environment, the one or more base stations will provide a region of intersection that may contain the mobile transmitter.

Those skilled in the art should readily recognize that this signal cancellation for the purposes of location estimation may be implemented in handset-based solutions, network-based solutions or hybrid combinations thereof. For example, in a handset-based solution using TOAs of signals (forward-link, base station to mobile signals) from at least two different base stations, the SNRs (e.g., those SNRs improved through signal cancellation) may be used to ascertain the location of the handset relative to the known, fixed locations of the base stations.

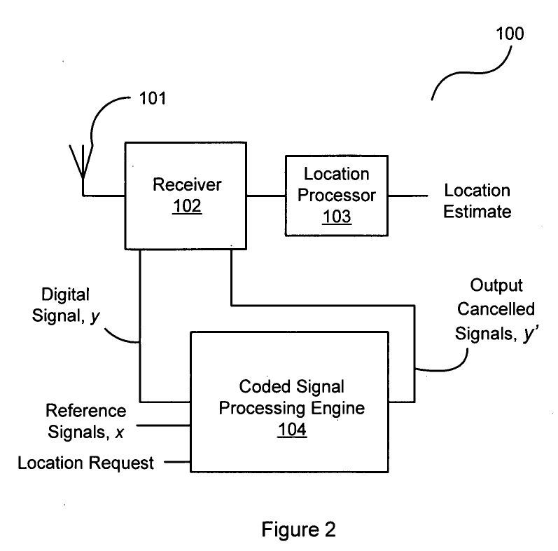

FIG. 2 is a block diagram of system 100 in one exemplary embodiment of the invention. In this embodiment, CSPE 104 may improve SNR of a selected signal through signal cancellation of interfering signals. The improved SNR improves tracking of the selected signal in receiver 102 and subsequent location processing by location processor 103.

CSPE 104 is communicatively coupled to receiver 102 to substantially cancel certain interfering signals from a digital signal y. For example, receiver 102 may receive a plurality of CDMA signals via antenna 101. Receiver 102 transfers a digital representation of those signals to CSPE 104 in digital signal y. CSPE 104 receives this signal, and possibly other signals such as reference signals x, to substantially cancel interfering signals as selected by the CSPE.

In one embodiment of the invention, CSPE 104 selects certain interfering signals and generates a cancellation operator from those signals. CSPE 104 then applies the cancellation operator to an input signal to substantially cancel the interfering signals from a Signal Of Interest (SOI). The application of the cancellation operator results in one or more output cancelled signals y′ with the interfering signals substantially removed and, thus, improved SNRs for the signals y′. CSPE 104 provides these output cancelled signals y′ to receiver 102 for tracking.

A location processor is communicatively coupled to receiver 102 for estimating a location of a device. In a handset embodiment, receiver 102 is a handset receiver configured for processing one or more signals of selected base stations, such as those described in FIG. 1. In this embodiment, selected signals that interfere with the base station signals have been substantially cancelled by CSPE 104 to generate output cancelled signals y′. Location processor 102 is, therefore, communicatively coupled to receiver 102 to estimate a location of the handset based on one or more processed output cancelled signals y′ in this handset-based embodiment.

Alternatively, location processor 103 may be configured to estimate a location of the handset in a network-based embodiment. In such an embodiment, receiver 102 may be a base station receiver configured for receiving selected handset signals. CSPE 104 may improve SNR of a selected handset signal and transfer the output cancelled signal y′ to receiver 102. Location processor 103 may, therefore, SNR values improved from cancellation to generate a location estimate.

Other base station receivers may also contribute signals improved from using output cancelled signals y′ to assist in location estimation. For example, location processor 103 may be a configured within a CDMA network to receive a plurality of processed signals and/or their associated SNRs.

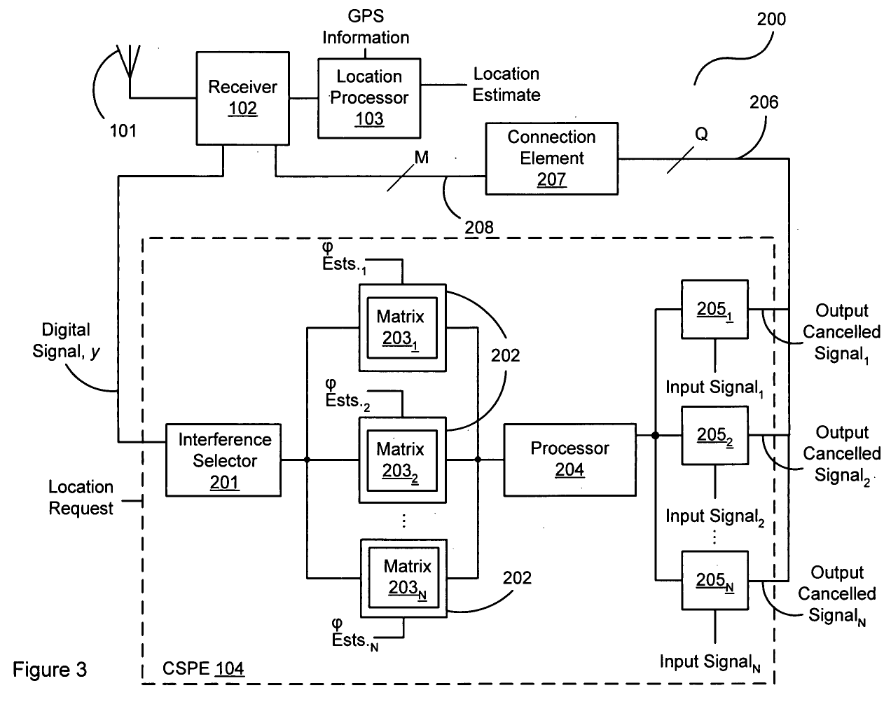

FIG. 3 is a block diagram of system 200 illustrating components of CSPE 104 in one exemplary embodiment of the invention. In this embodiment, CSPE 104 is configured for canceling certain interfering signals from a digital signal y to improve the SNR of a selected signal comprised therewith. For example, receiver 102 receives, via antenna 101, a plurality of signals comprising interfering signals and SOIs. Receiver 102 transfers a digital representation of that plurality of signals to CSPE 104 in the form of digital signal y. CSPE 104 selects one or more of those interfering signals to substantially remove from the digital signal y, thereby improving the SNR of the SOI(s). CSPE 104 transfers one or more output canceled signals (labeled output cancelled signals_{1 . . . N}) to receiver 102 for processing and subsequent location estimation (i.e., via location processor 103).

In this embodiment, CSPE 104 is configured with interference selector 201. Interference selector 201 is configured for receiving the digital signal y and selecting one or more interfering signals for cancellation from the digital signal. For example, the digital signal y may comprise one or more signal paths, wherein each signal path comprises one or more channels. Of those received signal paths, some of the signal paths/channels interfere with a signal selected for the demodulation. Interference selector 201 selects one or more of those interfering signal paths/channels for cancellation.

Interference selector 201 transfers selected interfering signal paths/channels to matrix generators 202. Each of matrix generators 202 receives a portion of the selected interfering signal paths/channels to generate an interference matrix 203 (labeled matrix 203_{1 . . . N}). For example, each matrix generator 202 may generate an interference matrix from certain interfering signal path/channel combinations that excludes a signal, such as a pilot channel, from a unique base station. Matrix construction is exemplified in the '834 application.

With each matrix constructed of interfering signal path/channel combinations that each exclude a unique signal, CSPE 104 may substantially cancel those interfering signal path/channel combinations. For example, processor 204 may be configured for generating a cancellation operator from each of the matrices 203. The cancellation operators, as applied to input signals (labeled Input Signals_{1 . . . N}) by applicators 205 (labeled 205_{1 . . . N}), substantially remove the selected interfering signal path/channel combinations from the input signal. Accordingly, applicators 205 generate associated Output Cancelled Signals_{1 . . . N} in which the selected interfering signal path/channel combinations are substantially removed.

In one embodiment of the invention, the cancellation operators are projection operators that are used to project selected signals substantially orthogonal to the selected interfering signal path/channel combinations. For example, processor 105 can use matrices 103 to generate projection operators according to the following form:

Pₛ^{⊥}=I−S(S^{T}S)⁻¹S^{T}, (Eq. 1)

where Pₛ^{⊥} is a projection operator, I is an identity matrix, S is an interference matrix 103 and S^{T} is a transpose of the matrix 103. Such projection operators and their associated constructions are described in the '346, the '360, the '829 and the '834 applications.

The output canceled signals_{1 . . . N} are transferred to receiver 102 via connection element 207. For example, “Q” channel connection 205 may be a communicative connection such as a data bus that allows for the transfer of “Q” number of channels to connection element 206, where Q is an integer greater than 1 and not necessarily equal to to the number of output cancelled signals N. Connection element 206 selectively transfers a “M” number of Output Cancelled Signals_{1 . . . N} to receiver 102 via “M” channel connection 208, where “M” is also an integer greater than or equal to Q.

The Q number of Output Cancelled Signals_{1 . . . N} that are effectively transferred to receiver 102 are thereby tracked by the receiver. These signals have improved SNRs that are useful in location processing. As such, tracked Output Cancelled Signals_{1 . . . N} are transferred to location processor 103 for location processing.

In one embodiment of the invention, receiver 102 and location processor 103 are configured within a mobile handset. In this embodiment, Output Cancelled Signals_{1 . . . N} comprise one or more pilot channels from one or more unique base stations. For example, signal cancellation performed by CSPE 104 may improve the SNRs of one or more unique base stations such that location processor 103 may generate a location estimate based on these pilot channels. Location processor 103 receives these improved pilot channel(s) and generates a location estimate of the mobile handset using one or more known location algorithms. The addition of more pilot channels may improve the quality of the location estimate as location algorithms are better to a able to resolve location ambiguity.

In another embodiment of the invention, receiver 102 is a receiver for a base station. Location processor 103 is configured as part of a network-based implementation of location estimation. In this embodiment, one of Output Cancelled Signals_{1 . . . N} is that from a particular mobile handset transferred to base station receiver 102. Receiver 102 tracks this output cancelled signal and transfers it to location processor 103 for location estimation. In this network-based location estimation, location processor 103 may receive this improved SNR as a result of cancellation of the mobile handset from one or more base stations. Location processor 103 may therefore estimate the location of the handset using one or more known location algorithms that compute the location of the handset-based on the known fixed locations of the base stations and the received signals from those base stations. Again, the improvement in the SNRs of the visible base stations and/or the addition of signals from additional base stations may improve the quality of the location estimate.

In one embodiment of the invention, location processor 103 is configured for receiving GPS information to assist in location estimation. For example, in mobile handset-based location estimation, the mobile handset may be configured with GPS circuitry that allows the handset to estimate its location. This information, in conjunction with the location estimate of the known processing algorithms may provide an improved location estimate because the resolution of the location estimate may be improved. This location estimate may therefore be transferred from the handset to a base station in communication therewith, thereby making the location estimate available to those in need of such information.

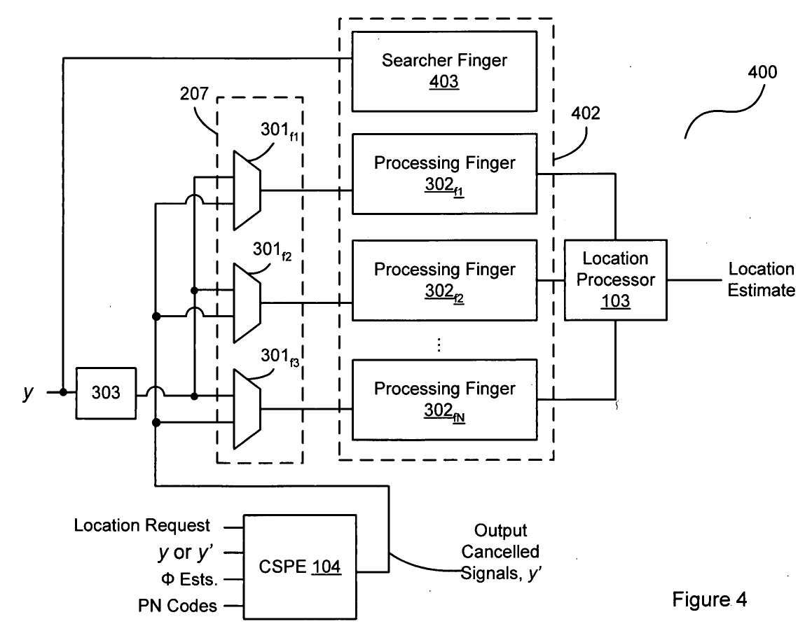

FIG. 4 is a block diagram of system 400 illustrating an exemplary embodiment of receiver 402 operable with CSPE 104 and location processor 103 in one exemplary embodiment of the invention. In this embodiment, receiver 402 comprises a plurality of processing fingers (labeled 302_{f1} . . . 302_{fN}). These processing fingers are communicatively coupled to connection element 207 for receiving one or more output canceled signals y′, such as those described in FIG. 3.

In one exemplary embodiment, a processing finger (e.g., processing finger_{f1}) processes the pilot channel from a first base station while receiver 402 searches for a pilot channel of a second base station. Once the pilot channel of the second base station is located, CSPE 104, as decided by a controller, cancels the first pilot channel and other associated channels from the signal path to determine if the SNR of the second pilot channel is improved. If the SNR is improved, the second pilot channel is tracked by a processing finger (e.g., processing fingers_{f2}) using the interference cancelled signal, otherwise the pilot channel is tracked using the uncancelled signal. If the SNR is insufficient and CSPE 104 cannot improve the SNR, CSPE 104 considers a third pilot channel. The cancellation process may continue until the desired resolution of the location algorithm or the desired number of base stations is reached.

Processed signals (e.g., those processed by processing fingers_{f1 . . . fN}) are transferred to location processor 103 for generating a location estimate. For example, location processor 103 may employ one or more known location determination algorithms to estimate the location of a handset-based on the processed signals.

Also illustrated in this embodiment is searcher finger 403. Searcher finger 403 is configured for detecting signals and assigning certain detected signals to the processing fingers. Such a searcher finger may be typical of a rake receiver as known to those skilled in the art.

Those skilled in the art should readily recognize that system 400 may be used to determine the location of the handset in either a handset-based location estimation solution or a network-based location estimation solution, as described in FIG. 3. For example, receiver 402 may be configured with a base station which tracks and processes multiple handset signals via processing fingers_{f1 . . . fN}. Similar receivers may be configured with other base stations which also may track and process multiple handset signals. Accordingly, base station receivers tracking the same mobile handset signal may transfer their respective processed signals to location processor 103 for subsequent location estimation of the mobile handset.

While one preferred embodiment has been shown in described, the invention is not intended to be limited to the preferred embodiment. Those skilled in the art should readily recognize that other implementations for location estimation may fall within the scope and spirited the invention. For example, the number of selectors and/or processing fingers illustrated in the preferred embodiment may be determined as a matter of design choice. Accordingly, the invention is only intended to be limited to the language recited in the claims and their equivalents. Other receiver features, such as those of receiver 402, and connection features, such as those of connection element 207, are shown and described in the '777 and the '346 applications, which are incorporated by reference.

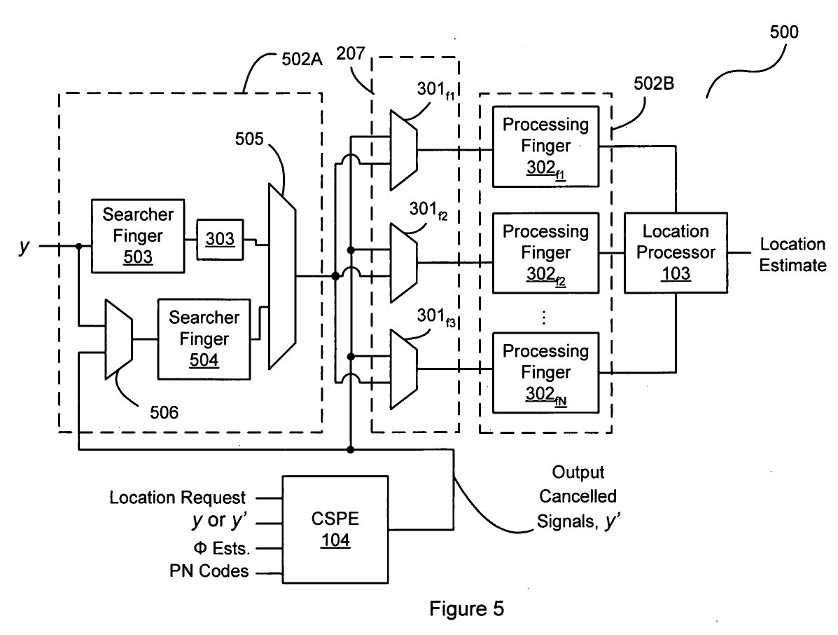

FIG. 5 is a block diagram of system 500 illustrating an exemplary embodiment of receiver 502 (illustrated as 502A and 502B) operable with CSPE 104 and location processor 103 in one exemplary embodiment of the invention. In this embodiment, output canceled signals, such as those described in FIG. 3, are again transferred to processing fingers 302_{f1 . . . fN} of receiver 102 for tracking. The tracked signals are again processed by location processor 103 to generate a location estimate in either a handset-based or a network-based location estimation solution.

Differing from FIG. 4, receiver 502 is also illustrated with searcher fingers 503 and 504. In this embodiment, searcher finger 503 is configured for receiving a digital signal y to search for pilot channels. The searcher finger 504, however, is configured for receiving or an output canceled signal y′ as selected by selector 506.

In this embodiment, searcher finger 504 may search for the pilot channels from one or more of an output canceled signal y′ that has one or more interfering signals substantially removed. Such an implementation may assist searcher finger 504 in the detection of previously undetectable pilot channels. For example, as some interfering signals may diminish the SNR of an SOI, signal cancellation of those interfering signals by CSPE 104 may improve the SNR of other signals to a level which searcher finger 504 can detect. Once detected, a signal may be selectively transferred to connection element 207 via selector 404. For example, based on a decision by receiver 502, selector 505 may transfer either a delayed version of the detected signal from searcher finger 503 or the undelayed version of the detected signal from searcher finger 504.

While one exemplary preferred embodiment has been shown and described herein, those skilled in the art should readily recognize that other embodiments may fall within the scope and spirit of the invention. For example, searcher 504 may be configured with CSPE 104 such that signals to be used for location estimation are detected initially within CSPE 104. Accordingly, the invention is not intended to be limited to preferred embodiment shown and illustrated herein. Rather, the invention is only intended to be limited to the language recited in the claims and their equivalents.

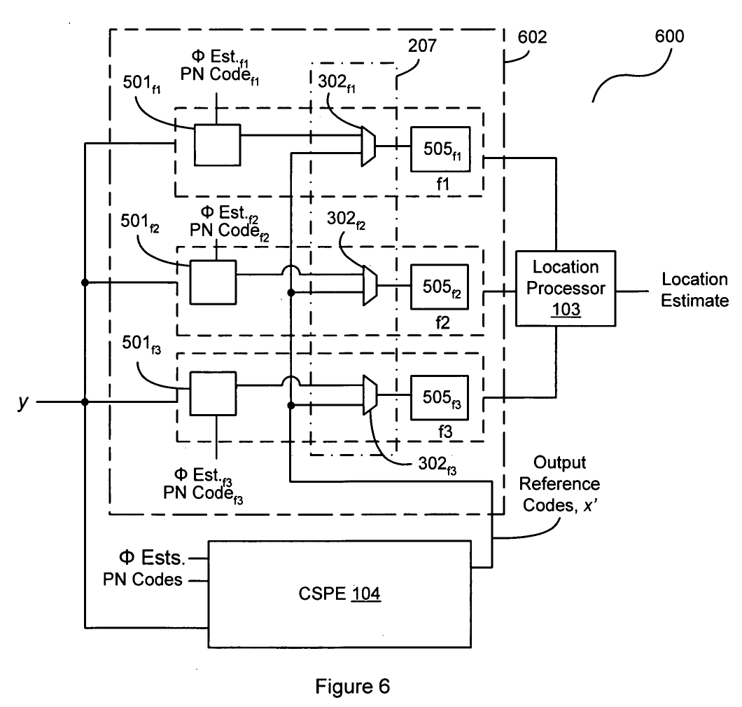

FIG. 6 is a block diagram of a system illustrating an exemplary embodiment of receiver 602 operable with CSPE 104 and location processor 103 in one exemplary embodiment of the invention. In this embodiment, receiver 602 is configured for receiving output reference codes x′ from CSPE 104 and using those codes to demodulate SOIs. The processed signals may again be transferred to location processor 103 for generating the location estimate.

In one embodiment, selectors 302 (labeled 302_{f1 . . . f3}) select between uncancelled PN codes and output cancelled PN codes (e.g., output reference codes x′) of signals processed by the processing fingers f1 . . . f3. For example, a selector may select either a PN code as determined by element 501 (labeled 501_{f1 . . . f3}) or an output cancelled PN code as provided by CSPE 104. Demodulators 505 (labeled 505_{f1 . . . f3}) may use a selected PN code to demodulate a signal assigned to a particular processing finger. This embodiment of receiver 102 is shown and described in the previously mentioned '777 and the '346 applications.

As with FIGS. 4 and 5, location estimation may be performed as part of a handset-based location estimation solution or a network-based location estimation solution. One distinction between the receiver embodiment of FIG. 6 and the receiver embodiments of FIGS. 4 and 5 lies in the cancellation of interfering reference codes from the output reference codes x′. For example, the '777 and the '346 applications illustrate the exemplary application of a cancellation operator to reference codes (i.e., PN Codes_{f1 . . . f3}) such that other reference interfering codes are substantially canceled. The resultant output reference codes x′ may therefore be transferred to receiver 602 for improved processing and tracking of their associated signals.

Canceling interfering reference codes may have the effect of substantially canceling certain components of the interfering signals associated with those interfering signals. Accordingly, the SNR of an SOI may be increased for reasons stated herein. SOIs having increased SNRs improves location estimation because, among other reasons, processing fingers 505_{f1 . . . f3} can more effectively demodulate the SOIs.

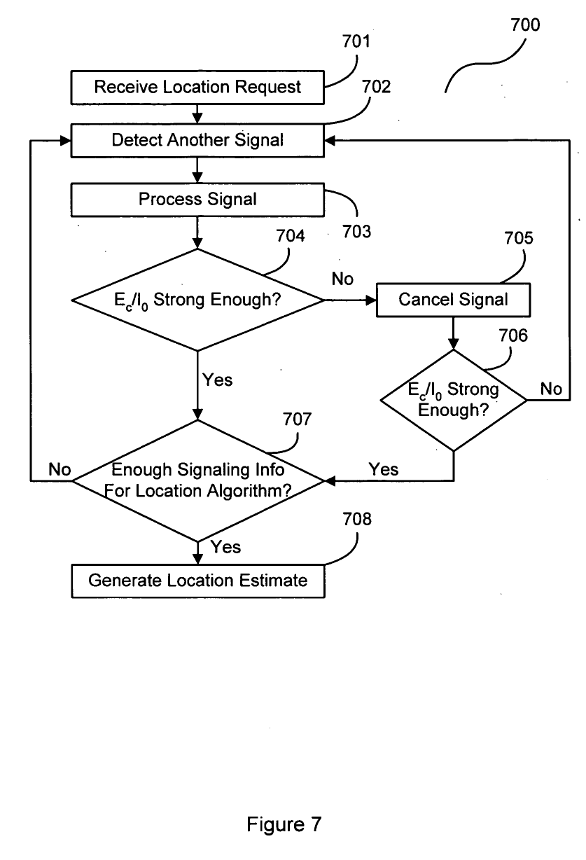

FIG. 7 is flowchart 700 in one exemplary methodical embodiment of the invention. In this embodiment, a location request is received, in element 701. The location request may initiate detection of another signal, in element 702. Once the other signal is detected, the signal may be processed by a processing finger of a receiver, such as that shown and described in FIGS. 4, 5 and 6, in element 703.

In processing the signal, a determination may be made with respect to the signal strength of the signal. For example, a processing finger may determine if the ratio of energy per chip of a selected signal to the total energy of a received signal (i.e., E_{c}/I₀) is strong enough for a processing finger to process, in element 704. If E_{c}/I₀ is strong enough, another determination may be made as to whether enough signaling information has been obtained for a location estimate by a location estimation algorithm, in element 707. If enough signaling information exists to generate a location estimate, a location estimate is generated in element 708. However, if the requisite amount of signaling information does not exist, another signal may be detected, in element 702.

If E_{c}/I₀ is not strong enough in element 704, certain selected interfering signals may be canceled, in element 705. Upon cancellation of these interfering signals, a determination may again be made with respect to E_{c}/I₀, in element 706. If E/Io is not strong enough, the method attempts to detect another signal, in element 702. If Ec/Io, however, is strong enough, then the method determines whether enough signaling information has been obtained to generate a location estimate using a known location algorithm, in element 707. Once again, if not enough information exists, the process returns to element 702 to detect another signal. Alternatively, if enough information does exist, a location estimate is generated in element 708.

While one preferred embodiment has been shown and described herein, the invention is not intended to be limited to the preferred embodiment. Neither is the invention intended to be limited to any process embodied by the above-mentioned systems. For example, the method described in shown herein may be implemented within either of the systems illustrated in FIGS. 4 and 6. Moreover, the method described in shown herein may be operable within a handset-based location estimation solution and/or a network-based location estimation solution. Accordingly, invention is only intended to be limited by claims and their equivalents.

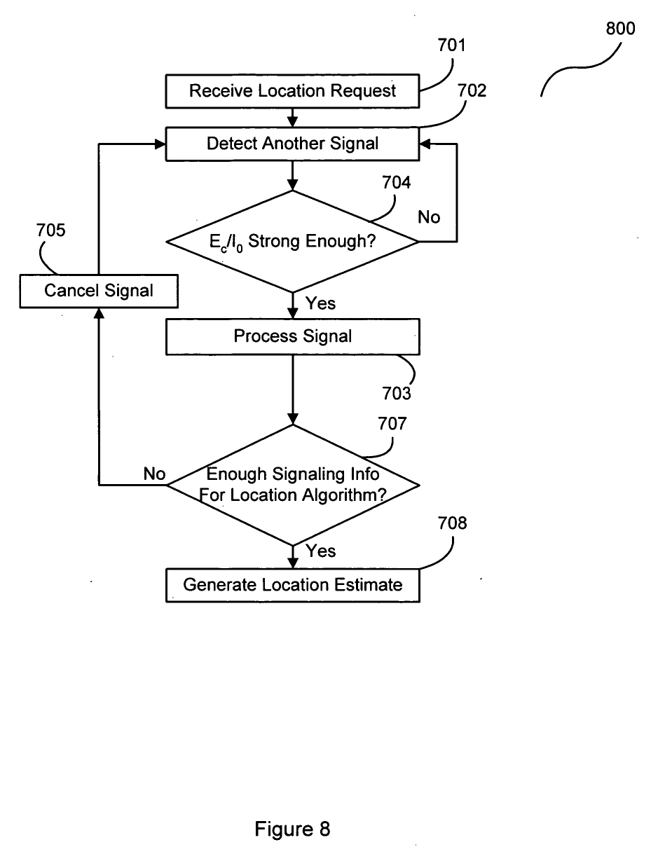

FIG. 8 is flowchart 800 in one exemplary methodical embodiment of the invention. In this embodiment, a location request is received, in element 701. Again, the location request may initiate detection of another signal, in element 702. Differing from FIG. 7, however, once the SOI is detected, a determination may be made with respect to the signal strength (i.e., E_{c}/I₀) of the signal, in element 704. Once the determination is made processing of a detected signal may be performed by a processing finger of a receiver, such as that shown and described in FIGS. 4, 5 and 6, in element 703. Such processing may include processing of a cancelled or an uncancelled signal. If the signal strength (i.e., E_{c}/I₀) is found not to be strong enough in element 704, detection of another signal is performed in element 702.

Upon processing the signal, a determination is made regarding the amount of signaling information available for a location estimation algorithm, in element 707. If not enough signaling information is available, cancellation of one or more selected interfering signals is performed in element 705. Subsequently, detection of another signal is performed in element 702. However, if enough signaling information is available, a location estimate is generated in element 708.

While one preferred embodiment has been shown and described herein, the invention is not intended to be limited to the preferred embodiment. Neither is the invention intended to be limited to any process embodied by the above-mentioned systematic embodiments. For example, the method described in shown herein may be implemented within the system illustrated in FIG. 5. Moreover, the method described and shown herein may be operable within a handset-based location estimation solution and/or a network-based location estimation solution. Accordingly, invention is only intended to be limited by claims and their equivalents.

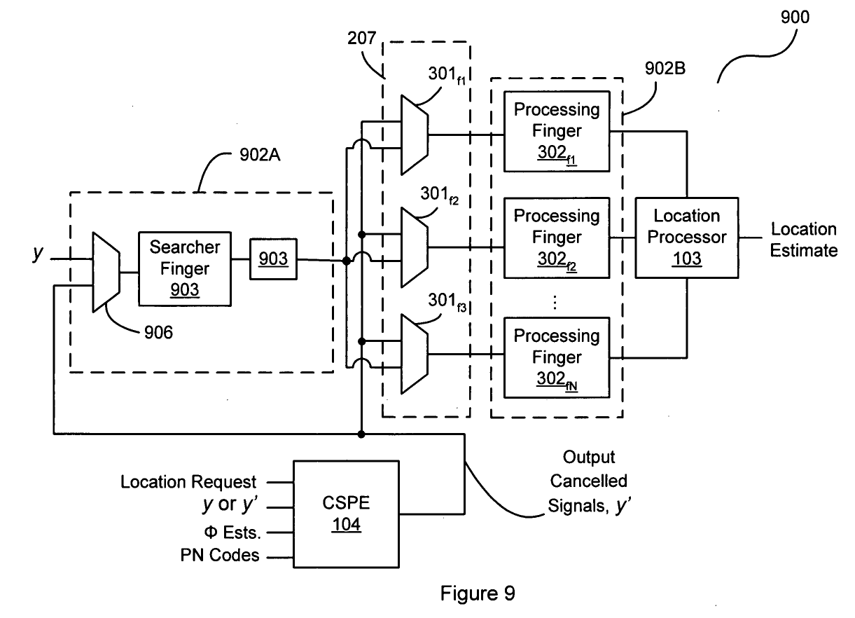

FIG. 9 is a block diagram of system 900 illustrating an exemplary embodiment of receiver 902 (illustrated as 902A and 902B) operable with CSPE 104 and location processor 103 in one exemplary embodiment of the invention. In this embodiment, output canceled signals, such as those described in FIG. 3, are again transferred to processing fingers 302_{f1 . . . fN} of receiver 902 for tracking. The tracked signals are again processed by location processor 103 to generate a location estimate in either a handset-based or a network-based location estimation solution.

Differing from FIG. 5, receiver 902 is configured with a searcher finger 903 that receives either of output canceled signals or an uncancelled digital signal y to search for pilot signals. Delay element 903 selectively applies a delay to the signal output from searcher finger 903, e.g. the delay may be applied to the uncancelled signal and not applied to the cancelled signal, depending on the input to the searcher finger 903. The selection of signals to be received by the searcher finger is performed by selector 906. Control functionality (in this embodiment as well as the embodiments shown and described in FIGS. 3, 4, 5 and 6) used to perform such a selection may reside with either CSPE 104 or with the receiver.

Signal cancellation for the purposes of location determination may be performed on any of a received signal y, an interference cancelled signal y′, a reference code x and/or an interference cancelled reference code x′. Additionally, the invention is not intended to be limited to the concept of handset signal cancellation. Base stations may be configured for performing such location determinations based on a signal received from a handset. Moreover, the signal cancellation may be performed on either mobile telephony signals and/or on GPS signals.

Further, while the exemplary embodiments described herein with a predominant focus on CDMA, the invention is not intended to be limited such embodiments. Rather, other embodiments that fall within the scope and spirit of invention may be implemented in systems using CDMA signals, W-CDMA signals, GPS signals and/or other coded signals.

While the invention has been illustrated and described in detail in the drawings and foregoing description, such illustration and description is to be considered as exemplary and not restrictive in character. Accordingly, it should be understood that only the preferred embodiment and minor variants thereof have been shown and described and that all changes and modifications that come within the spirit of the invention are desired to be protected.

What is claimed is:

1. A system for estimating a position location of a mobile station in a spread spectrum system, comprising:
a processing engine configured to selectively and substantially cancel one or more interfering signals from a digital signal and to generate one or more interference cancelled output signals;
a receiver communicatively coupled to the processing engine and configured for processing the one or more interference cancelled output signals to generate signaling information; and
a location processor configured to process the signaling information to generate a location estimate.

2. The system of claim 1, wherein the processing engine comprises an interference selector configured for selecting said one or more interfering signals for cancellation.

3. The system of claim 2, wherein the processing engine further comprises a matrix generator configured for generating an interference matrix from selected said one or more interfering signals.

4. The system of claim 3, wherein the processing engine further comprises a processor configured for generating a cancellation operator from the interference matrix.

5. The system of claim 4, wherein the processing engine further comprises an applicator configured for applying the cancellation operator to the digital signal to substantially cancel the selected said one or more interfering signals and to generate one of the one or more interference cancelled output signals.

6. The system of claim 4, wherein the projection operator substantially comprises the form:
Pₛ^{⊥}=I−S(S^{T}S)⁻¹S^{T},
where Pₛ^{⊥} is the projection operator, I is an identity matrix, S is the matrix and S^{T} is a transpose of the matrix.

7. The system of claim 1, wherein the receiver comprises a plurality of processing fingers, wherein each processing finger is configured for processing one of the one or more interference cancelled output signals to generate a portion of the signaling information.

8. The system of claim 1, wherein the system further comprises a first searcher finger configured for receiving one of the one or more interference cancelled output signals to detect a selected signal.

9. The system of claim 8, wherein the first searcher finger is configurable with at least one of the receiver and the processing engine.

10. The system of claim 8, wherein the first searcher finger is communicatively coupled with a second searcher finger, wherein the second searcher finger is configured for receiving an uncancelled signal.

11. The system of claim 1, wherein the system is configurable with a mobile handset.

12. The system of claim 1, wherein the location processor is further configured to use GPS information to assist the location processor in generating the location estimate.

13. The system of claim 1, wherein the spread spectrum system is a CDMA system, a W-CDMA system or a GPS system.

14. A method of estimating a location of a mobile station in a spread spectrum system, comprising:
processing a first signal to generate signaling information of the first signal in response to receiving a location request;
substantially canceling the first signal to process a second signal and to generate signaling information of the second signal; and
generating a location estimate from the signaling information of the second signal.

15. The method of claim 14, wherein generating the location estimate comprises processing the signaling information of the first signal and processing the signaling information of the second signal to generate the location estimate.

16. The method of claim 14, further comprising substantially canceling the second signal to process a third signal and to generate signaling information of the third signal.

17. The method of claim 16, wherein generating the location estimate comprises processing the signaling information to generate the location estimate, wherein the signaling information is selected from a group consisting of: the signaling information of the first signal; the signaling information of the second signal; and the signaling information of the third signal.

18. The method of claim 17, wherein processing the signaling information to generate the location estimate comprises processing the signaling information using one or more location algorithms selected from a group consisting of: Time of Arrival, Angle of Arrival; Frequency of Arrival; Time Difference of Arrival; and Frequency Difference of Arrival.

19. The method of claim 14, further comprising processing GPS information to assist in generating the location estimate.

20. The method of claim 14, further comprising acquiring the second signal with a searcher finger in response to substantially canceling the first signal.

21. A method of estimating a position location of a mobile station in a spread spectrum system, comprising:
processing a first signal to generate signaling information of the first signal;
determining if substantially canceling the first signal improves signal quality in a second signal;
substantially canceling the first signal to process the second signal and to generate signaling information of the second signal in response to determining that the signal quality of the second signal is improved; and
generating a location estimate using the signaling information of the second signal.

22. The method of claim 21, further comprising receiving a location request that initiates the method of estimating the location.

23. The method of claim 21, wherein generating the location estimate comprises processing the signaling information of the first signal and processing the signaling information of the second signal to generate the location estimate.

24. The method of claim 21, further comprising substantially canceling the second signal to process a third signal and to generate signaling information of the third signal.

25. The method of claim 24, wherein generating the location estimate comprises processing the signaling information to generate the location estimate, wherein the signaling information is selected from a group consisting of: the signaling information of the first signal; the signaling information of the second signal; and the signaling information of the third signal.

26. The method of claim 25, wherein processing the signaling information to generate the location estimate comprises processing the signaling information using one or more location algorithms selected from a group consisting of: Time of Arrival, Angle of Arrival; Frequency of Arrival; Time Difference of Arrival; and Frequency Difference of Arrival.

27. The method of claim 21, further comprising processing GPS information to assist in generating the location estimate.

28. The method of claim 21, further comprising acquiring the second signal with a first searcher finger in response to substantially canceling the first signal.

29. The method of claim 21, further comprising acquiring the first signal with a second searcher finger.

30. A system for estimating a location of a mobile station in a spread spectrum system, comprising:
means for processing a first signal to generate signaling information of the first signal in response to receiving a location request;
means for substantially canceling the first signal to process a second signal and to generate signaling information of the second signal; and
means for generating a location estimate from the, signaling information of the second signal.

31. The system of claim 30, wherein the means for generating the location estimate comprises means for processing the signaling information of the first signal and means for processing the signaling information of the second signal to generate the location estimate.

32. The system of claim 30, further comprising means for substantially canceling the second signal to process a third signal and to generate signaling information of the third signal.

33. The system of claim 32, wherein the means for generating the location estimate comprises means for processing the signaling information to generate the location estimate, wherein the signaling information is selected from a group consisting of: the signaling information of the first signal; the signaling information of the second signal; and the signaling information of the third signal.

34. The system of claim 33, wherein the means for processing the signaling information to generate the location estimate comprises means for processing the signaling information using one or more location algorithms selected from a group consisting of: Time of Arrival, Angle of Arrival; Frequency of Arrival; Time Difference of Arrival; and Frequency Difference of Arrival.

35. The system of claim 30, further comprising means for processing GPS information to assist in generating the location estimate.

36. The system of claim 30, further comprising means for acquiring the second signal with a searcher finger using an output cancelled signal in response to substantially canceling the first signal.

37. A system for estimating a position location of a mobile station in a spread spectrum system, comprising:
means for processing a first signal to generate signaling information of the first signal;
means for determining if substantially canceling the first signal improves signal quality in a second signal;
means for substantially canceling the first signal to process the second signal and to generate signaling information of the second signal in response to determining that the signal quality of the second signal is improved; and
means for generating a location estimate using the signaling information of the second signal.

38. The system of claim 37, further comprising means for receiving a location request that initiates the method of estimating the location.

39. The system of claim 37, wherein the means for generating the location estimate comprises means for processing the signaling information of the first signal and means for processing the signaling information of the second signal to generate the location estimate.

40. The system of claim 37, further comprising means for substantially canceling the second signal to process a third signal and to generate signaling information of the third signal.

41. The system of claim 40, wherein the means for generating the location estimate comprises means for processing the signaling information to generate the location estimate, wherein the signaling information is selected from a group consisting of: the signaling information of the first signal; the signaling information of the second signal; and the signaling information of the third signal.

42. The system of claim 41, wherein the means for processing the signaling information to generate the location estimate comprises means for processing the signaling information using one or more location algorithms selected from a group consisting of: Time of Arrival, Angle of Arrival; Frequency of Arrival; Time Difference of Arrival; and Frequency Difference of Arrival.

43. The system of claim 37, further comprising means for processing GPS information to assist in generating the location estimate.

44. The system of claim 37, further comprising means for acquiring the second signal with a searcher finger using an output cancelled signal in response to substantially canceling the first signal.

45. The system of claim 37, further comprising means for acquiring the first signal with a second searcher finger.
